(19) United States
(12) Patent Application Publication
(10) Pub. No.: US 2006/0280320 A1
(43) Pub. Date: Dec. 14, 2006

(54) Surface mountable electret condenser microphone

(75) Inventors: Chungdam Song, Seoul (KR); Eekjoo Chung, Gyeonggi-do (KR); Hyunho Kim, Incheon-si (KR); Sungho Park, Incheon-si (KR)

Correspondence Address: CANTOR COLBURN, LLP, 55 GRIFFIN ROAD SOUTH, BLOOMFIELD, CT, 06002, US

(73) Assignee: BSE CO., LTD., Incheon (KR)

(21) Appl. No.: 10/566,304

(22) PCT Filed: Aug. 29, 2003
(86) PCT No.: PCT/KR03/01758

§ 371 Date: Jan. 27, 2006

(30) Foreign Application Priority Data
Jul. 29, 2003 (KR) 10-2003-0052193

(51) Int. Cl. H04R 25/00

(52) U.S. Cl. 381/174

(57) ABSTRACT

Disclosed is an electret condenser microphone capable of surface mounting which has a structure highly resistant to high temperature. The electret condenser microphone comprises a case, a polar ring, a diaphragm, a spacer, a back-plate, a first base, a second base and a printed circuit board (PCB), wherein the first base surrounds the diaphragm, the spacer and the back-plate, so that the first base prevents characteristics of an electret formed on any one of the diaphragm and the back-plate from being deteriorated in a reflow process for surface mounting. Further, in order to prevent sensitivity of the electret condenser microphone from being lowered due to decrease of an electrical potential value of the electret in the reflow process. High gain IC devices are used. The electret condenser microphone capable of surface mounting can be obtained by, first, using main components made from a high-temperature resistant insulating material, for example, a polymer-, a plastic- or a fluoro resin-based material, second, constructing the first base to surround acoustic based components, third, using a cream solder for high temperature to bond components to the PCB, fourth, using the high gain IC devices, fifth, providing the connecting terminal with gas discharge grooves and protruding the connecting terminal to be higher than a curled surface of the electret condenser microphone.

### FIELD OF THE INVENTION

The present invention relates to an electret condenser microphone, and more particularly to a surface mountable electret condenser microphone which has a structure highly resistant to high temperature.

### BACKGROUND ART

A typical condenser microphone comprises a voltage bias element (e.g., an electret), a diaphragm/back-plate pair forming a capacitor changing in response to a sound pressure, and a JFET (Junction Field Effect Transistor) for buffering output signals. This electret condenser microphone has an electret formed on any one of the diaphragm and the back-plate. Particularly, the electret formed on the diaphragm is called a front electret, and the electret formed on the back-plate is called a back electret. Typically, the electret is formed by forcibly implanting electric charge into an organic film.

FIG. 1 schematically shows a conventional electret condenser microphone.

As shown in FIG. 1, the conventional electret condenser microphone includes a case 102 made of a cylindrical metal; a polar ring 104 constituted of a conductor; a diaphragm 106; a spacer 108; a back-plate 110; a first annular base 112 constituted of an insulator; a second base 114 constitued of a conductor; and a PCB 116 mounted with circuit elements 118 and formed with connecting terminals 120 and 122.

However, the conventional electret condenser microphone has a problem in that it is difficult to employ surface mounting technique, because most components, such as the back-plate on which the electret is formed, etc., are not made from a high-temperature resistant material. In addition, even though they are of a high-temperature resistant material, the electret has a charge value changed at a high temperature, thus having a reduced sensitivity. In other words, as technology for producing electronic products is developed, there has been a tendency to make electronic products more compact. In order to produce such compact products, surface mounting technology (SMT) has been widely used. According to SMT, surface mounted components are exposed to a high temperature during a reflow process. For this reason, it is not suitable to apply the SMT to temperature sensitive components. In addition, the electret condenser microphone has another problem in that, because the electret is formed by forcibly implanting electrons into an organic film (e.g., FEP (fluoroethylenepropylene copolymer), PET (polyethylene terephthalate), PTFE (polytetrafluoroethylene) or the like), which is fused on a metallic plate, increase of moisture or temperature forces implanted electrons to be easily separated, so that performance of the electrect becomes lowered.

### SUMMARY OF THE INVENTION

Accordingly, the present invention has been made to solve the above-mentioned problems occurring in the prior art, and an object of the present invention is to provide an electret condenser microphone capable of surface mounting by a structure enclosing an electret with a base having an insulating characteristic so as not to allow deterioration of properties of the electret at high temperatures, using a high-temperature resistant material, and using IC devices having a high gain so as to prevent a sensitivity decrease of the microphone caused by a decrease of an electric potential value of the electret during a reflow process for surface mounting.

In order to accomplish this object, there is provided a surface mountable electret condenser microphone comprising a case, a polar ring, a diaphragm, a spacer, a back-plate, a first base, a second base and a printed circuit board (PCB), wherein the first base surrounds the diaphragm, the spacer and the back-plate, thereby preventing deterioration of characteristics of an electret formed on any one of the diaphragm and the back-plate in a reflow process for surface mounting. Further, in order to prevent sensitivity of the electret condenser microphone from being lowered due to decrease of an electrical potential value of the electret in the reflow process for surface mounting, high gain IC devices are used.

Here, at least one of the first base, the diaphragm, the spacer and the back-plate is made from any one selected from polymer-based materials of ASA, Nylon 6, Nylon 66, Nylon 46, LCP, PBT, PC, PC/ABS, PC/PBT, PEEK, PEN, PES, PET, PMMA, POM, PTFE, SAN, PPS, SBR and TPU, and from fluoro resin-based materials of PTFE(TFE), FEP, PFA, ETFE, CTFE, PVDF, PVE, PCTFE, ECTFE, EPE, Nylon 6, PP and hard PVC. The PCB allows various components to be mounted thereon, the components being soldered by any one selected from cream solders for high temperature of Sn/Ag, Sn/Cu, Sn/Ag/Cu, Sn/Ag/Cu/Sb (CASTIN™ alloy) and Sn/Ag/Cu/Bi (OATEY™ alloy).

Further, the PCB is provided with a connecting terminal for connecting with an external circuit, the connecting terminal including a circular terminal for Vdd connection in the center, and annular sector ground terminals evenly spaced apart from each other along the periphery, the annular sector ground terminals being separated by the grooves so as to allow gases generated during the reflow process to be discharged, the circular terminal for Vdd connection and the annular sector ground terminals protrude to be higher than the surface of the PCB, so that a short circuit which may be generated during the reflow process for surface mounting is adapted to be prevented.

### BRIEF DESCRIPTION OF THE DRAWINGS

The above and other objects, features and advantages of the present invention will be more apparent from the following detailed description taken in conjunction with the accompanying drawings, in which:

FIG. 1 schematically shows a conventional electret condenser microphone;

FIG. 2 is a sectional view showing the entire structure of an electret condenser microphone according to the present invention;

FIG. 3 is a plan view showing one example of the connecting terminal of FIG. 2;

FIG. 4 is a sectional view of the connecting terminal of FIG. 3;

FIG. 5 is a plan view showing one example in which a ball grid array is formed to the connecting terminal of FIG. 2; and

FIG. 6 is a sectional view of the connecting terminal of FIG. 5.

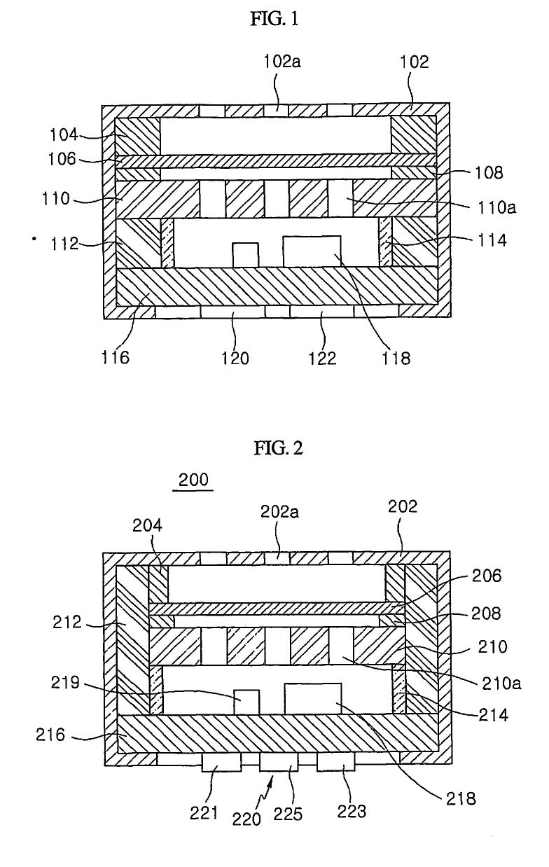

### DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

FIG. 2 is a sectional view showing the entire structure of an electret condenser microphone according to the present invention.

As shown in FIG. 2, the electret condenser microphone according to the present invention has an acoustic part and a PCB circuit part, both of which are integrally assembled by a single cylindrical case 202.

The acoustic part is adapted to be formed in the same cylindrical shape as the cylindrical case 202 to be fitted into the case 202. Further, the acoustic part is adapted to be protected by a first base 212 made from an insulating material having a good high-temperature resistance, and includes a diaphragm 206 and a back-plate 210 facing each other inside of the first base 212. There is located a spacer 208 between the diaphragm 206 and the back-plate 210.

The diaphragm 206 is supported in indirect contact with the case 202 by a cylindrical polar ring 204 constituted of a conductor, wherein the case 202 is formed with at least one sound aperture 202a. The back-plate 210 is supported on a PCB 216 by a second cylindrical base 214 constituted of a conductor. Either the diaphragm 206 or the back-plate 210 is formed with an electret. In this case, the electret formed on the diaphragm 206 is called a front electret, while the electret formed on the back-plate 210 is called a back electret. The back-plate 210 is formed with at least one through-hole 210a for endowing the electret condenser microphone with a directional characteristic.

Referring to FIG. 2, the back-plate 210, the spacer 208, the diaphragm 206 and the first base 212 are all made from a fluoro resin-, polymer- or plastic-based material having a heat- and chemical-resistant characteristic. In other words, according to the present invention, a high-temperature resistant material is used for components of the electret condenser microphone, so that the electret condenser microphone capable of surface mounting can be produced. As examples of the high-temperature resistant material, there are various kinds of materials, such as a fluoro resin-based material, a polymer-based material, a plastic-based material and so on. Further, the high-temperature resistant material may be used in a predetermined shape, such as a film, a sheet, a roll, or a bulk. To be more specific about the high-temperature resistant material, the polymer-based material is exemplified by ASA, Nylon 6, Nylon 66, Nylon 46, LCP, PBT, PC, PC/ABS, PC/PBT, PEEK, PEN, PES, PET, PMMA, POM, PTFE, SAN, PPS, SBR, TPU or so forth. The fluoro resin-based material is exemplified by PTFE(TFE), FEP, PFA, ETFE, CTFE, PVDF, PVE, PCTFE, ECTFE, EPE, Nylon 6, PP, hard PVC or so on.

The first and second bases 212 and 214 are supported by the PCB 216 and simultaneously define an internal space together with the PCB 216. A plurality of circuit components, such as an IC 218, an MLCC 219 and so forth, are mounted on the PCB 216. Here, as one example of the IC which is mounted on the PCB 216, there is a field effect transistor (FET), an embedded gain amplifier or the like. The IC mounted on the PCB 216, if necessary, may include an analog-to-digital converter for digital conversion, a decimation filter, a digital interface IC and so on.

Further, in order to prevent components 218 and 219 mounted on the PCB 216 from being separated during a reflow process, a cream solder for high temperature is ssed to bond other components. The cream solder for high temperature available to the embodiment of the present invention has various kinds, such as Sn/Ag, Sn/Cu, Sn/Ag/Cu, Sn/Ag/Cu/Sb (CASTIN™ alloy), Sn/Ag/Cu/Bi (OATEY™ alloy) and so on.

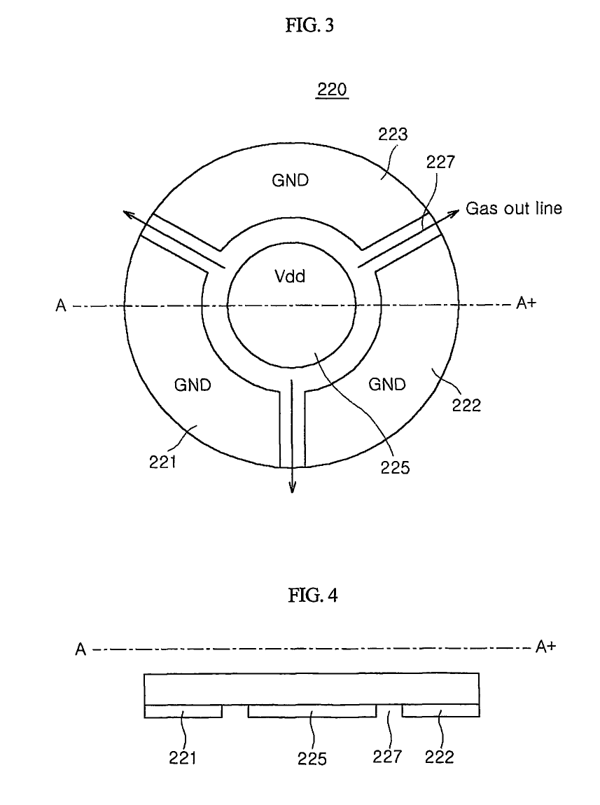

Meanwhile, the PCB 216 is provided with at least one connecting terminal 220, so that the electret condenser microphone 200 can be surface-mounted on another PCB (e.g., for a cellular phone). To this end, the connecting terminal 220, as shown in FIGS. 3 and 4, includes a circular terminal 220 for Vdd connection in the center, and annular sector ground terminals 221 to 223 evenly spaced apart from each other along the periphery. These annular sector ground terminals 221 to 223 are separated by three gas discharge grooves 227 so as to allow gases generated during a surface mounting process to be discharged. That is, the electret condenser microphone of the present invention is designed to discharge gases generated from the cream solder during a reflow process for surface mounting, and specifically to protrude the connecting terminal 220 to be higher than a curled surface of the electret condenser microphone, so that the connecting terminal facilitates to connect with another PCB during a reflow process for surface mounting.

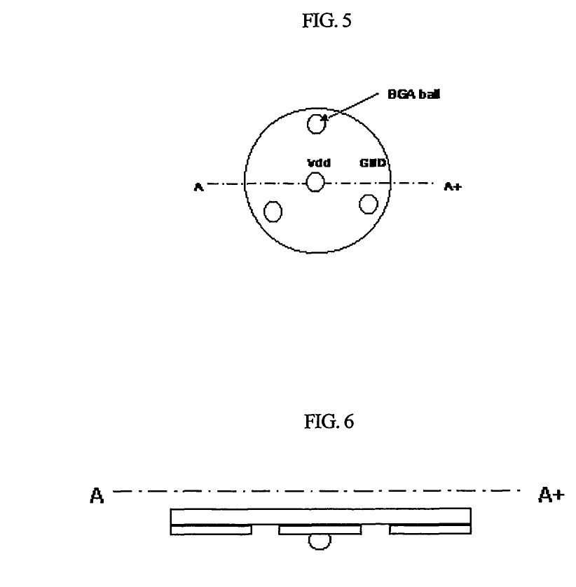

Alternatively, the connecting terminal, as shown in FIGS. 5 and 6, has a ball grid array for high temperature in order to make balls of the ball grid array higher than a curled surface of the electret condenser microphone, so that the connecting terminal facilitates to connect with another PCB during a reflow process for surface mounting. Hereinafter, description will be made regarding how the electret condenser microphone of the present invention is operated.

When the connecting terminal 220 of the electret condenser microphone according to the present invention is connected with an external circuit board and then supplied with Vdd and GND electric power, the electret condenser microphone starts to be operated. In this case, the diaphragm 206 is electrically connected with the PCB 216 through the polar ring 204 and the case 202. The back-plate 210 is electrically connected with the PCB 216 through the second base 214.

Under this situation, when a user speaks, a sound pressure generated by the sound aperture 202a is applied to the diaphragm 206. Thus, the diaphragm 206 is vibrated to force an interval between the diaphragm 206 and the back-plate 210 to vary. This interval variation caused by the sound pressure forces capacitance formed by the diaphragm 206 and the back-plate 210 to vary, so that it is possible to obtain variation of electrical signal (i.e., voltage) according to the sound pressure. The electrical signal is amplified by being transmitted through the second base 214 to the IC 218 mounded on the PCB 216, and then sent to the outside through the connecting terminal 220.

Meanwhile, the electret condenser microphone according to the present invention is constructed so that the first base 212 made from a high-temperature resistant insulating material surrounds acoustic components (e.g., the diaphragm, the spacer, the back-plate, etc.), and thus it is possible to prevent characteristics of the electret from being deteriorated by high temperature during a reflow process for surface mounting. In other words, it is possible to prevent electric charge charged in the electret from being discharged even at a high temperature owing to the first base 212, so that the electret can be protected.

Further, in the electret condenser microphone 200 of the present invention, the diaphragm 206, the spacer 208, the back-plate 210, the first base 212, etc. are made from a high-temperature resistant material. Particularly, by forming the electret on a fluoro resin film for high temperature, the electret is designed not to severely change its own characteristic at a reflow temperature for surface mounting. The high gain IC devices are used to prevent sensitivity of the electret condenser microphone from being lowered due to decrease of an electrical potential value of the electret in a reflow process for surface mounting. In order to facilitate surface mounting relative to the electret condenser microphone 200, the electret condenser microphone 200 is designed not only to discharge detrimental gases generated from the cream solder during a reflow process for surface mounting, but also to protrude the connecting terminal.

Although preferred embodiments of the present invention have been described for illustrative purposes, those skilled in the art will appreciate that various modifications, additions and substitutions are possible, without departing from the scope and spirit of the invention as disclosed in the accompanying claims.

### INDUSTRIAL APPLICABILITY

As can be seen from the foregoing, according to the present invention, first, main components make use of a high-temperature resistant insulating material, for example, a polymer-based, a plastic-based or a fluoro resin-based material. Second, the fist base is constructed to surround acoustic based components. Third, the cream solder for high temperature is used to bond components to the PCB. Fourth, the high gain IC devices are used. Fifth, the connecting terminal is provided with gas discharge grooves and protrudes to be higher than a curled surface of the electret condenser microphone. Thereby, an electret condenser microphone capable of surface mounting can be obtained.

In the case of the conventional electret condenser microphone, it is impossible to carry out a reflow process at a temperature of 230° C. or more. However, in the case of the electret condenser microphone of the present invention, it is possible to carry out a reflow process at a temperature of 260° C. or more. Thus, in the case of products using the electret condenser microphone of the present invention, it is possible to improve the production process, to save the production costs, and to reduce the failure rate. Moreover, by using high gain IC devices, it is possible maintain a sensitivity change before and after a reflow process within an typical acceptable sensitivity of ±1 dB.

1. A surface mountable electret condenser microphone comprising a case, a polar ring, a diaphragm, a spacer, a back-plate, a first base, a second base, and a printed circuit board (PCB), wherein the first base surrounds the diaphragm, the spacer and the back-plate, thereby preventing deterioration of characteristics of an electret formed on any one of the diaphragm and the back-plate in a reflow process for surface mounting.

2. A surface mountable electret condenser microphone comprising a case, a polar ring, a diaphragm, a spacer, a back-plate, a first base, a second base, and a printed circuit board (PCB), wherein the first base surrounds an electret formed on any one of the diaphragm and the back-plate, thereby deterioration of characteristics of an electret formed on any one of the diaphragm and the back-plate in a reflow process for surface mounting.

3. A surface mountable electret condenser microphone as claimed in claim 1, wherein at least one of the first base, the diaphragm, the spacer and the back-plate is made from any one selected from polymer-based materials of ASA, Nylon 6, Nylon 66, Nylon 46, LCP, PBT, PC, PC/ABS, PC/PBT, PEEK, PEN, PES, PET, PMMA, POM, PTFE, SAN, PPS, SBR and TPU, and from fluoro resin-based materials of PTFE(TFE), FEP, PFA, ETFE, CTFE, PVDF, PVE, PCTFE, ECTFE, EPE, Nylon 6, PP and hard PVC.

4. A surface mountable electret condenser microphone as claimed in claim 1, wherein the PCB allows various components to be mounted thereon, the components being soldered by any one selected from cream solders for high temperature of Sn/Ag, Sn/Cu, Sn/Ag/Cu, Sn/Ag/Cu/Sb (CASTIN™ alloy) and Sn/Ag/Cu/Bi (OATEY™ alloy).

5. A surface mountable electret condenser microphone as claimed in claim 4, wherein the PCB allows IC devices to be mounted thereon, the IC devices including a field effect transistor.

6. A surface mountable electret condenser microphone as claimed in claim 4, wherein the PCB allows IC devices to be mounted thereon, the IC devices including a built-in gain amplifier.

7. A surface mountable electret condenser microphone as claimed in claim 4, wherein the PCB allows IC devices to be mounted thereon, the IC devices including an analog-digital converter for digital conversion.

8. A surface mountable electret condenser microphone as claimed in claim 4, wherein the PCB allows IC devices to be mounted thereon, the IC devices including decimation filter and a digital interface IC.

9. A surface mountable electret condenser microphone as claimed in claim 1, wherein the PCB is provided with a connecting terminal for connecting with an external circuit, the connecting terminal being formed with at least one groove for discharging gases generated in the reflow process for surface mounting.

10. A surface mountable electret condenser microphone as claimed in claim 9, wherein the connecting terminal includes a circular terminal for Vdd connection in the center, and annular sector ground terminals evenly spaced apart from each other along the periphery, the annular sector ground terminals being separated by the grooves so as to allow gases generated during the reflow process to be discharged.

11. A surface mountable electret condenser microphone as claimed in claim 9, wherein the connecting terminal protrudes to be higher than a curled surface of the electret condenser microphone, whereby facilitating connection with another PCB in the reflow process for surfacing mounting.

12. A surface mountable electret condenser microphone as claimed in claim 9, wherein the connecting terminal has a ball grid array for high temperature in order to make balls of the ball grid array higher than a curled surface of the electret condenser microphone, whereby facilitating connection with another PCB during the reflow process for surface mounting.

13. A surface mountable electret condenser microphone as claimed in claim 2, wherein at least one of the first base, the diaphragm, the spacer and the back-plate is made from any one selected from polymer-based materials of ASA, Nylon 6, Nylon 66, Nylon 46, LCP, PBT, PC, PC/ABS, PC/PBT, PEEK, PEN, PES, PET, PMMA, POM, PTFE, SAN, PPS, SBR and TPU, and from fluoro resin-based materials of PTFE(TFE), FEP, PFA, ETFE, CTFE, PVDF, PVE, PCTFE, ECTFE, EPE, Nylon 6, PP and hard PVC.

14. A surface mountable electret condenser microphone as claimed in claim 2, wherein the PCB allows various components to be mounted thereon, the components being soldered by any one selected from cream solders for high temperature of Sn/Ag, Sn/Cu, Sn/Ag/Cu, Sn/Ag/Cu/Sb (CASTIN™ alloy) and Sn/Ag/Cu/Bi (OATEY™ alloy).

15. A surface mountable electret condenser microphone as claimed in claim 14, wherein the PCB allows IC devices to be mounted thereon, the IC devices including a field effect transistor.

16. A surface mountable electret condenser microphone as claimed in claim 14, wherein the PCB allows IC devices to be mounted thereon, the IC devices including a built-in gain amplifier.

17. A surface mountable electret condenser microphone as claimed in claim 14, wherein the PCB allows IC devices to be mounted thereon, the IC devices including an analog-digital converter for digital conversion.

18. A surface mountable electret condenser microphone as claimed in claim 14, wherein the PCB allows IC devices to be mounted thereon, the IC devices including decimation filter and a digital interface IC.

19. A surface mountable electret condenser microphone as claimed in claim 2, wherein the PCB is provided with a connecting terminal for connecting with an external circuit, the connecting terminal being formed with at least one groove for discharging gases generated in the reflow process for surface mounting.

20. A surface mountable electret condenser microphone as claimed in claim 19, wherein the connecting terminal includes a circular terminal for Vdd connection in the center, and annular sector ground terminals evenly spaced apart from each other along the periphery, the annular sector ground terminals being separated by the grooves so as to allow gases generated during the reflow process to be discharged.

21. A surface mountable electret condenser microphone as claimed in claim 19, wherein the connecting terminal protrudes to be higher than a curled surface of the electret condenser microphone, whereby facilitating connection with another PCB in the reflow process for surfacing mounting.

22. A surface mountable electret condenser microphone as claimed in claim 19, wherein the connecting terminal has a ball grid array for high temperature in order to make balls of the ball grid array higher than a curled surface of the electret condenser microphone, whereby facilitating connection with another PCB during the reflow process for surface mounting.
